(19) United States
(12) Patent Application Publication
(10) Pub. No.: US 2024/0182682 A1
(43) Pub. Date: Jun. 6, 2024

(54) ANTIMICROBIAL AIR FILTER

(71) Applicant: Industrial Polymers and Chemicals, Inc., Shrewsbury, MA (US)

(72) Inventors: Thomas J. Kennedy, lll, Harwich, MA (US); Ralph G. Dacey, JR., Shrewsbury, MA (US); Robert Roth, St. Louis, MO (US)

(21) Appl. No.: 18/382,244

(22) Filed: Oct. 20, 2023

Related U.S. Application Data
(60) Provisional application No. 63/418,767, filed on Oct. 24, 2022.

(51) Int. Cl. C08K 5/19; B01D 39/16; C08K 9/12; F24F 3/16

(52) U.S. Cl. CPC C08K 5/19; B01D 39/16; C08K 9/12; F24F 3/16; B01D 2239/0266; B01D 2239/0442; B01D 2239/0618; C08K 2201/018

(57) ABSTRACT

The application describes a polymer matrix that features a polymer mixed with an antimicrobial agent (e.g., a pathogen inactivating material). The polymer can be an ablative or a sacrificial polymer that will degrade over time in either a surface or bulk degradation method. In some embodiments, the polymer matrix can also include a labile molecule built into the backbone of the polymer.

### CROSS-REFERENCE TO RELATED APPLICATIONS

This application claims the benefit of priority to U.S. Provisional Patent Application No. 63/418,767 entitled “Pathogen Inactivating Filter,” filed on Oct. 24, 2022, the contents of which are incorporated by reference herein in its entirety.

### TECHNICAL FIELD

The present application generally related to antimicrobial agents (e.g., pathogen inactivating materials) and, more particularly, to such agents infused within an ablative or sacrificial polymer.

### BACKGROUND

Air filters for heating, ventilation, and air conditioning (HVAC) systems provide excellent filtration of particles. Depending upon the rating of the filter, smaller and smaller particles may be filtered out of the air. A specific type of filter, high efficiency particulate air (HEPA) filter, is utilized to filter micron and submicron particles from the air.

While very fine particle filters offer trapping of allergens and other problematic materials such as fine dust, all of these passive air filters do not allow for the inactivation of pathogens that may be borne by the air as it flows through the HVAC system. High Efficiency Particulate Air (HEPA) filters may also cause a high pressure drop across the filter, resulting in poor airflow through the HVAC system.

Thus, there is therefore a need for a long-lasting, pathogen inactivating, and high percentage capture air filter for HVAC systems that minimizes the pressure drop in the air flow after the filter.

### SUMMARY

The embodiment is the use of air filter or filters comprised of paper, woven fiberglass, nonwoven fiberglass, nonwoven polymers, and the like where the air filter or filters further comprise a method of inactivating pathogens through the use of a compound or compounds that are infused or coated into or onto the air filters.

The air filter or filters further comprise a polymer that is infused or mixed with a compound, such as an antimicrobial agent (e.g., a biocide or pathogen inactivating material), that will kill or inactivate pathogens such as viruses, bacteria, and/or fungi. The polymer may also have ablative or sacrificial characteristics where the surface of the polymer may wear away with time (as described and defined in greater detail below), exposing a new fresh surface of the polymer. While in many instances this application will refer to a pathogen inactivating material, in all such instances the application should be read to support the concept that the pathogen inactivating material can be any antimicrobial agent (which as a class is broader than pathogen inactivating materials), e.g., any substance that can kill and/or inhibit the growth of any microorganism such as bacteria, viruses, fungi, etc., on contact or interaction.

The ablative or sacrificial polymer may be an emulsion polymer comprised of a polyvinyl acetate and acrylate backbone where the outer surface of the polymer will be worn away over time, exposing a new surface to the environment.

The ablative or sacrificial polymer may also be from the group of polycaprolactone (PCL), poly(lactic-co-glycolic acid) (PLGA), and polyglycidyl methacrylate (PGMA). These polymers will degrade readily in standard temperature and pressure (STP) conditions such as the environment of an office building, school, or residence. In the case of a residence, the residence may be temporary, such as a hotel or motel, or permanent, such as a house or apartment.

The pathogen inactivating material or biocide infused polymer may also be compounded such that, when coated onto the filter substrate, provides a supply of the pathogen inactivating material or biocide to the air that is flowing through the filter. Through the wearing away of the polymer, in various embodiments, the supply of pathogen inactivating material can be supplied to the air continuously and/or intermittently.

One method of accomplishing this is to introduce a large excess of pathogen inactivating material or biocide into the polymer mixture such that the pathogen inactivating material or biocide comes to the surface of the polymer through surface energy, diffusion, capillary action, or other passive transport mechanisms.

Yet another method of supplying a replenishing (continuously or intermittently) amount of pathogen inactivating material is for the ablative or sacrificial polymer matrix to wear away over time while continuously exposing the pathogen inactivating material that has been infused into the polymer matrix to the environment.

The polymer matrix may refer to the ablative or sacrificial polymer alone or the ablative or sacrificial polymer infused or mixed with other materials, such as a pathogen inactivating material.

The polymer that is coated on the filter system may also be of such a nature that it is incompatible with the biocide or pathogen inactivating material such that the biocide or pathogen inactivating material, or any other material that would inactivate a pathogen, is allowed to ooze or flow out of the polymer matrix. This would be similar to a permanently oiled bearing where oil is infused into a sintered bearing and thus has long life lubrication as the oil oozes out of the sintered bearing. The polymer matrix may be a solid, solution, or emulsion type. The polymer may be borne by an organic solvent or may be waterborne or maybe 100% solids.

The pathogen inactivating material or biocide may be a blend of pathogen inactivating materials or biocides, each having a different target area of pathogens. As a result, multiple pathogens, such as Legionella, the pathogen causing Legionnaires' disease, and SARS-CoV-2, the virus causing the Covid-19 pandemic, may be inactivated at the same time. Also, bacteria and fungi may be inactivated.

Filter papers are used in many types of applications including air filters for HVAC units and automobiles, coffee filters, fuel filters, chromatography separation, laboratory filters, and teabags to name a few applications. Porous air filters in HVAC systems may be manufactured in a manner to allow particles of different sizes to be trapped while other sizes may pass through the filter.

These filter papers have benefited from continued refinement and engineering to provide sustained and precise filtration methods for various materials.

Single-digit and fractional micron filtration is possible with many different types of filter paper. The filter papers may also be treated with biocides and pathogen inactivating material s to improve the protection from infectious particles that may be circulating in the air.

The coating of the filter substrate may be accomplished by a spray, dip, roll, print, or other transfer process whereby an ablative or sacrificial polymer is transferred to the surface of the specialty paper. The ablative or sacrificial polymer may contain pathogen inactivating material such as a biocide or pathogen inactivating material. The roll process may be a Mayer rod process or a gravure process.

A fiberglass base material may be utilized for the HVAC filter. Here, the ablative or sacrificial polymer with a biocide or a pathogen inactivating material, or any other material that would inactivate a pathogen, is transferred to the fiberglass substrate. The fiberglass substrate may be woven or nonwoven. The ablative or sacrificial polymer will wear away over time and expose a new surface to the environment while it is coated on the fiberglass substrate.

The rating of the air filter may be of various levels. The American Society of Heating, Refrigerating and Air-Conditioning Engineers (ASHRAE) utilizes the standard as prescribed by ANSI/ASHRAE 52.2 for the Minimum Efficiency Reporting Value (MERV). A standard of MERV 13 or higher has been prescribed by the Center for Disease Control (CDC).

There are various antimicrobial agents (e.g., biocides and pathogen inactivating materials) available in the marketplace for the inactivation of pathogens, including the SARS-CoV-2 virus that is causing the Covid-19 pandemic. The biocides and pathogen inactivating materials include materials that incorporate chlorinated molecules such as quaternary ammonium salts with a chlorine molecule attached. Benzalkonium chloride is an example of a material with a quaternary ammonium component and a chlorine component. Many other types of biocides and pathogen inactivating materials are available such as sodium hypochlorite (commonly known as bleach), hydrogen peroxide, and isopropyl alcohol. Other molecules include boron, iodine, and other chlorine containing molecules.

The polymers that are utilized in this embodiment have special characteristics for the changes of the polymers over time. Both ablative polymers and sacrificial polymers may be utilized for the coating material on the air filters. Ablative polymers tend to break down from the surface due to external forces such as the flow of a fluid, such as air, over the surface of the ablative polymer. Sacrificial polymers tend to break down in a bulk manner where the entire sacrificial polymer begins to break down from external forces such as the flow of the fluid over the surface of the sacrificial polymer. Various polymeric properties may be manipulated to produce either an ablative polymer or a sacrificial polymer.

In one aspect, embodiments of the disclosure related to a polymer matrix that includes a polymer mixed with an antimicrobial agent, where the polymer is an ablative polymer or a sacrificial polymer that will degrade over time in either a surface or bulk degradation method.

In various embodiments, the polymer matrix can also include a degradation labile molecule built into a backbone of the polymer. In some instances, the degradation molecule is polymerized into the backbone of the polymer. In some instances, the degradation molecule is copolymerized into the backbone of the polymer. The polymer matrix can also include an enzyme adapted to increase the speed of the degradation of the polymer matrix either through an ablative process or a sacrificial process. In some cases, the polymer matrix has a high second Damköhler number (e.g., greater than 1). In other cases, the polymer matrix has a low second Damköhler number (e.g., less than 1). The polymer matrix can also include an absorptive material (e.g., silica gel, molecular sieve, clay, or zeolite material). The antimicrobial agent can be a pathogen inactivating material and/or a biocides. In some embodiments, the disclosure relates to an air filter that includes a substrate and the polymer matrix.

In another aspect, embodiments of the disclosure relate to a method of making a polymer matrix, the method including the steps of: mixing a polymer with an antimicrobial agent, where the polymer is an ablative polymer or a sacrificial polymer that will degrade over time in either a surface or bulk degradation method.

In various embodiments, the method can include the step of building a degradation labile molecule into a backbone of the polymer and/or adding an enzyme adapted to increase the speed of the degradation of the polymer matrix either through an ablative process or a sacrificial process. In some cases, the polymer has a high second Damköhler number. In some cases, the polymer has a low second Damköhler number. In some embodiments, the method includes adding an absorptive material.

### BRIEF DESCRIPTION OF THE DRAWINGS

The foregoing aspects and other features of the disclosed embodiments are explained in the following description, taken in connection with the accompanying drawings, wherein:

FIG. 1 illustrates an exemplary embodiment of an HVAC filter with a pathogen inactivating material infused coated fiberglass component, according to example embodiments.

FIG. 2 is a rendering of a HVAC filter with a pathogen inactivating material infused substrate and a holder for the substrate, according to example embodiments.

FIG. 3 is a chemical formula for benzalkonium chloride, according to example embodiments.

FIG. 4 is a chemical formula for poly(lactic-co-glycolic acid) (PLGA), according to example embodiments.

FIG. 5 is a chemical formula for polyglycidyl methacrylate (PGMA), according to example embodiments.

FIG. 6 is a table showing the MERV levels for air filters, according to example embodiments.

FIG. 7 is a depiction of a furanose molecule with a phosphodiester bond, according to example embodiments.

FIG. 8 is a, enzyme reaction process, according to example embodiments.

FIG. 9 is a molecule of hypochlorous acid, according to example embodiments.

FIG. 10 is a molecule of didecyldimethylammonium chloride, according to example embodiments.

FIG. 11 is a molecule of the repeating unit of a starch polymer, according to example embodiments.

FIG. 12 is a molecule of the repeating unit of a vinyl acetate butyl acrylate polymer, according to example embodiments.

FIG. 13 is a molecule of the repeating unit of a cellulose polymer, according to example embodiments.

FIG. 14 is the structure of a zeolite material, according to example embodiments.

FIG. 15 is a scanning electron micrograph (SEM) of an uncoated fiberglass substrate at 50 times, according to example embodiments.

FIG. 16 is a SEM of a coated fiberglass substrate at 50 times, according to example embodiments.

FIG. 17 is a SEM of an uncoated fiberglass substrate at 300 times, according to example embodiments.

FIG. 18 is a SEM of a coated fiberglass substrate at 300 times, according to example embodiments.

### DETAILED DESCRIPTION

The embodiments described herein disclose a HVAC filters system that is coated with a polymer where the polymer contains an agent for inactivating viruses. Specifically, the pathogen inactivating material in the polymer is used to inactivate the SARS-CoV-2 virus causing the Covid-19 pandemic.

The polymer may be an ablative or sacrificial polymer that will wear away at the surface over time, thus exposing new material to the environment. The polymer may also be a material that's incompatible with the inactivating agent such that the inactivating agent, a biocide or pathogen inactivating material for example, will ooze out of the polymer for a long period of time and thus inactivate viral particles when they impinge on the filter coated with this polymeric configuration.

An ablative or sacrificial polymer may also be known as a sacrificial material with the polymer subject to wear from environmental conditions. The ablation of a polymeric matrix may occur from thermal interaction, UV interaction, and other energetic, oxidating, or hydrogenating environmental interactions. The ablative or sacrificial polymer may also be comprised of nano composites. The sacrificial polymer may wear away and/or break down from environmental interactions.

The polymeric material, blended with a pathogen inactivating material, or any other pathogen inactivating material, may be applied to the substrate by various means such as spraying, dipping, roll coating, and printing. Once the polymer is applied to the substrate, it may be cured or dried through various processes such as UV cure, drying in a heated oven, or air dried.

Test procedures, such as ISO-18184:2019, may be utilized to demonstrate the anti-viral capacity of a porous substrates. In accordance with ISO-18184:2019, samples of a non-woven fiberglass with a MERV rating of 13 treated with a polyvinyl acetate/acrylate copolymer infused with Stepan BTC-885, a benzalkonium chloride containing mixture, were tested. A material containing essentially 99.9% benzalkonium chloride was also tested. The pathogen that was tested utilizing the ISO-18184:2019 standard was the SARS-CoV-2 virus, WA1 strain. The results of the testing show that the polymer and pathogen inactivating material infused non-woven fiberglass MERV 13 filter inactivated all of the SARS-CoV-2 WA1 virus in 15 minutes. The test results are listed below in Table 1.

TABLE 1

| | Project | | | Test | Contact | Log₁₀ |
|---|---|---|---|---|---|---|
| Protocol # | No. | Lot No. | Dilution | Virus | time | Reduction |
| IPAC.V.21.001 | 1123-101 | Test | N/A | Severe Acute | 15 | ≥3.39 |
| | | Material | | Respirator | Minutes | |
| | | | | Syndrome- | | |
| | | | | Related | | |
| | | | | Coronavirus 2 | | |
| | | | | (SARS-CoV-2) | | |
| | | | | (COVID-19 | | |
| | | | | Virus) | | |

The substrate that the polymer is coated onto may be composed of various materials. The materials include both woven and nonwoven fiberglass, paper, nonwoven polymeric matrices, woven polymeric matrices, and similar support materials.

A second set of testing was undertaken to determine the effect of a specific level of pathogen inactivating material. Table 2 is a listing of the test material.

TABLE 2

| | | |
|---|---|---|
| 1 | IPAC-06272022-001 | Polymer + 2.5% BTC-885 |
| 2 | IPAC-06272022-002 | Fiberglass control |
| 3 | IPAC-06272022-003 | Polymer + 2.5% BTC-885 |
| 4 | IPAC-06272022-004 | Polymer control |
| 5 | IPAC-06272022-005 | Fiberglass control |

The materials in table 2 were tested against the SARS-CoV-2 virus, Washington strain, utilizing a modified protocol as delineated in ISO-18184. The results are shown in table 3.

TABLE 3
Viral Reduction

| | | Contact | Initial Load | Output Load | Log₁₀ |
|---|---|---|---|---|---|
| Test Substance | Replicate | Time | (Log₁₀TCID₅₀)* | (Log₁₀TCID₅₀) | Reduction |
| IPAC-06272022-004 | 1 | 15 minutes | 6.31 | 5.60 | 0.71 |
| | 2 | | | 5.48 | 0.83 |
| | 3 | | | 5.48 | 0.83 |
| IPAC-062722022-003 | 1 | | | 4.48 | 1.83 |
| | 2 | | | 4.60 | 1.71 |
| | 3 | | | 4.98 | 1.33 |

*Input load is derived from the average of the three replicates of the liquid control
≥ Denotes a complete inactivation of the virus challenged.
Note:
The results are unaudited and preliminary. They are subject to change until the review is complete and a final report issued

Utilizing the coated filter, IPAC-06272022-003, a reduction in the amount of virus was shown versus the uncoated material control, IPAC-06272022-004. Thus, the polymer matrix infused with a pathogen inactivating material showed an inactivation of the SARS-CoV-2 virus.

A third set of results show the data in table 3 where different levels of benzalkonium chloride were infused into the polyvinyl acetate/acrylate polymer. The benzalkonium chloride in this test was a 99.5% material while the BTC-885 material is 50% active with the other 50% being surfactant materials.

TABLE 4

| | Number | Coating | Polymer |
|---|---|---|---|
| 1 | IPAC-08222022-004 | Fiberglass control - MERV-13 | None |
| | | JM | |
| 2 | IPAC-08222022-002 | Polymer control | SC-6125 |
| 3 | IPAC-08222022-003 | Polymer + 1.25% BAC | SC-6125 |
| 4 | IPAC-08222022-004 | Polymer + 2.5% BAC | SC-6125 |
| 5 | IPAC-08222022-005 | Polymer + 5.0% BAC | SC-6125 |
| 6 | IPAC-08222022-006 | Polymer + 10.0% BAC | SC-6125 |

Table 5 shows the results of the testing of the materials in table 2.

TABLE 5
Viral Reduction

| | | Contact | Initial Load | Output Load | Log₁₀ |
|---|---|---|---|---|---|
| Test Substance | Replicate | Time | (Log₁₀TCID₅₀)* | (Log₁₀TCID₅₀) | Reduction |
| IPAC-08222022-002 | 1 | 15 minutes | 5.92 | 5.60 | 0.32 |
| | 2 | | | 5.48 | 0.44 |
| IPAC-08222022-003 | 1 | | | 5.23 | 0.69 |
| | 2 | | | 4.85 | 1.07 |
| IPAC-08222022-004 | 1 | | | 3.85 | 2.07 |
| | 2 | | | 3.85 | 2.07 |
| IPAC-08222022-005 | 1 | | | 1.89 | 4.03 |
| | 2 | | | ≤2.13 | ≥3.79 |
| IPAC-08222022-006 | 1 | | | ≤2.13 | ≥3.79 |
| | 2 | | | ≤2.13 | ≥3.79 |

*Input load is derived from the average of the two replicates of the liquid control
≥Denotes a complete inactivation of the virus challenged.

This test is designed to evaluate the virucidal effectiveness of the polymer matrix consisting of at least a base ablative or sacrificial polymer and a pathogen inactivating material infused into the polymer matrix against SARS-associated Coronavirus Type 2 (SARS-CoV-2). The test determined the virucidal effectiveness of the pathogen inactivating material (indeed any antimicrobial agent) infused polymer matrix to inactivate the test virus via direct contact. The test is designed to simulate consumer use; and is based on the International Standard ISO 18184 method, “Textiles—Determination of Antiviral Activity of Textile Products”.

The results show the complete inactivation of the SARS-CoV-2 virus at a 10% level of the pathogen inactivating material and a complete inactivation to a 4.03 log reduction of the SARS-CoV-2 virus at a 5% level of the pathogen inactivating material.

The polymeric coated substrate may then be fitted into a frame such that it may easily be inserted into an HVAC system that currently accepts regular types of filtration media.

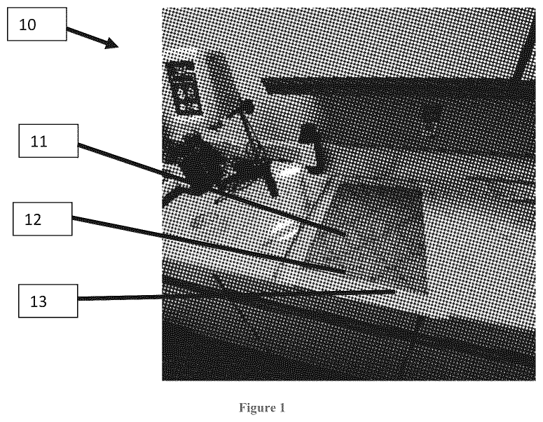

FIG. 1 illustrates a type of HVAC filter 10 where a coated fiberglass mesh 11 has been incorporated into a paper frame. The fiberglass mesh is coated with an ablative or sacrificial polymer 12 composed of a polyvinyl acetate and poly acrylate copolymer. The ablative or sacrificial polymer also contains a pathogen inactivating material, benzalkonium chloride 13.

FIG. 2 is a depiction of an air filter 20. The cross members 21 of the air filter frame 22 retain the filtration substrate 23. The filtration substrate 23 may be a woven or non-woven substrate. The material of the filter substrate 23 may be paper, fiberglass, or another suitable material. The filtration substrate 23 may be coated with a polymer where the polymer is infused with a pathogen inactivating material.

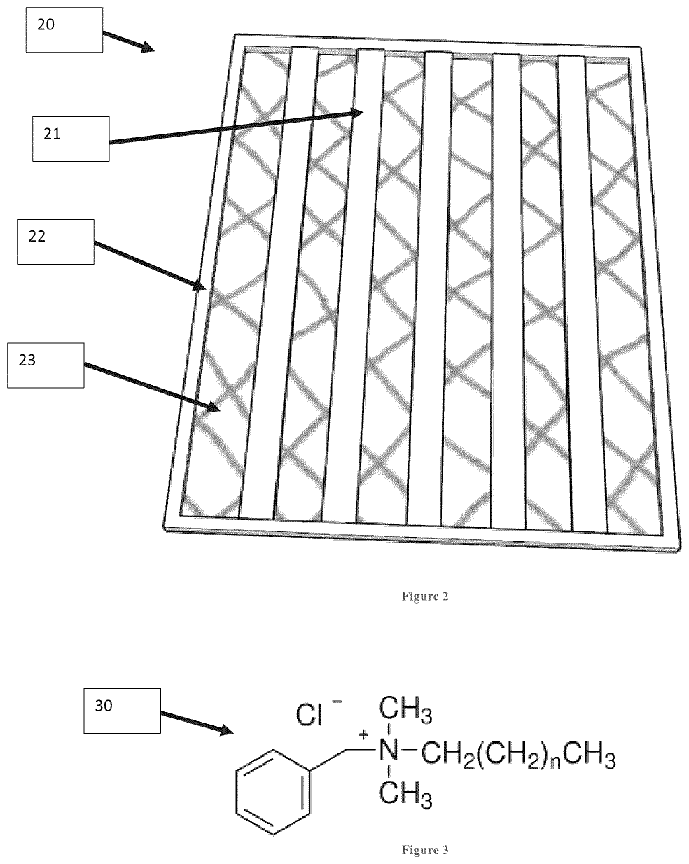

FIG. 3 depicts the benzalkonium chloride molecule 30, a strong anti-viral material.

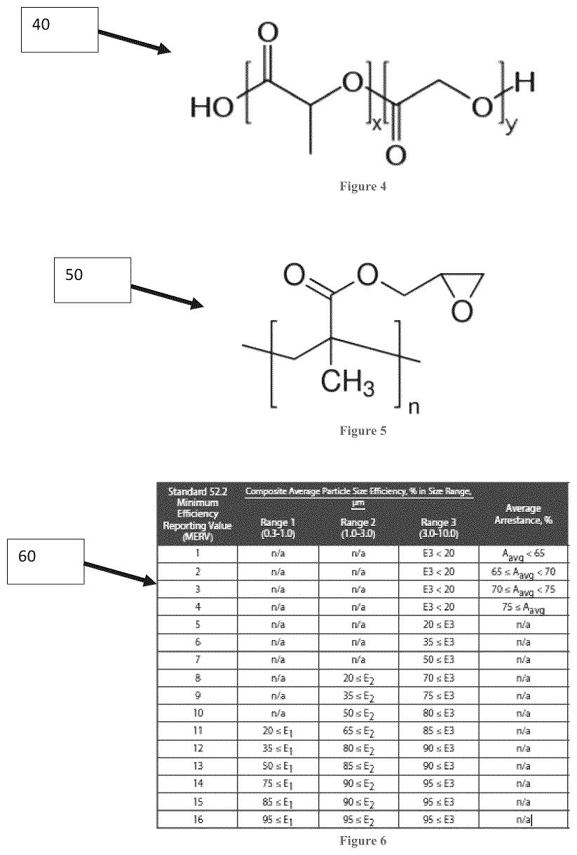

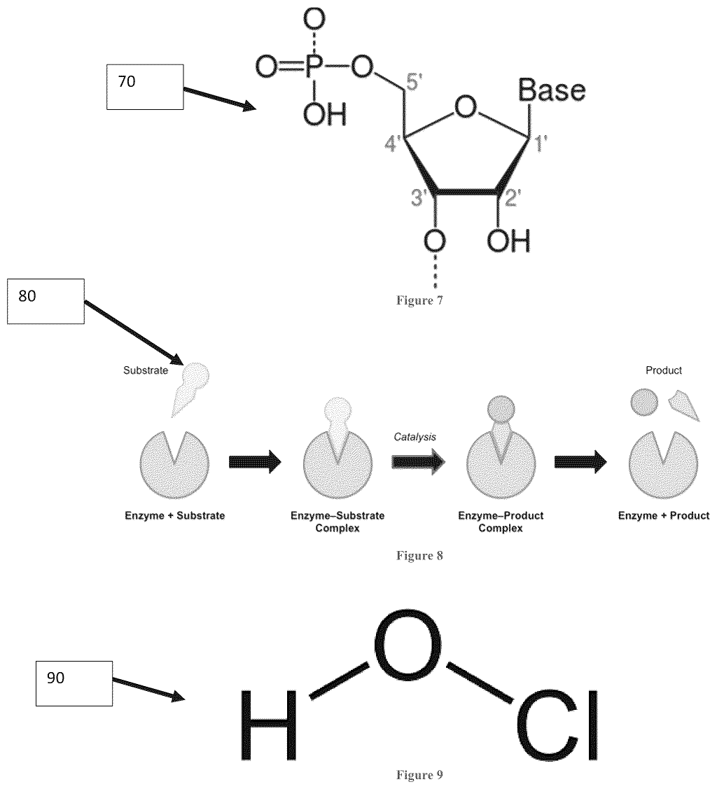

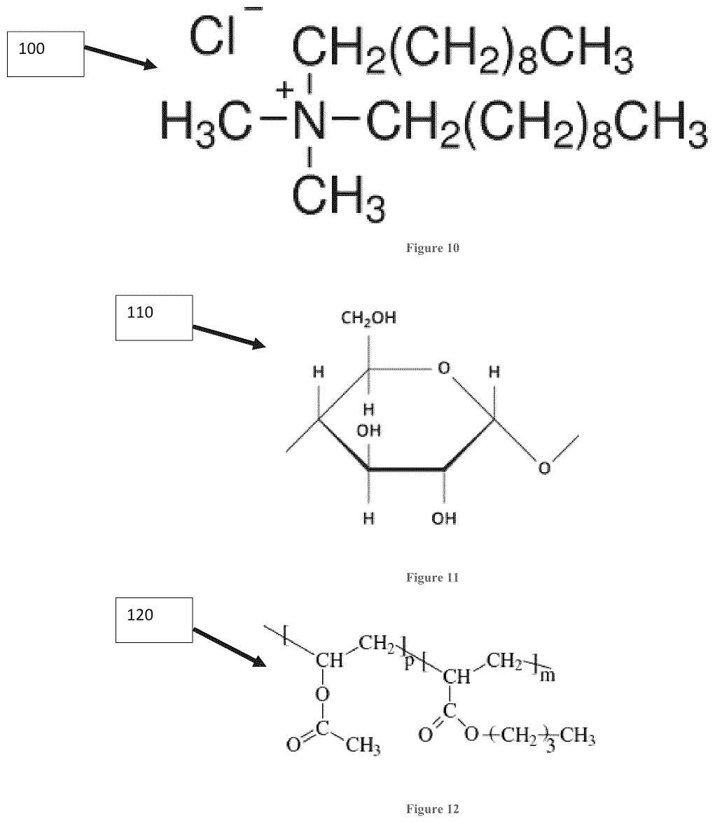

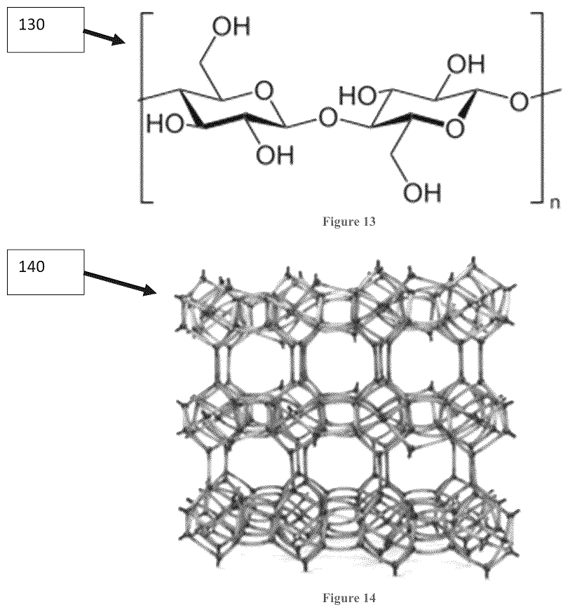

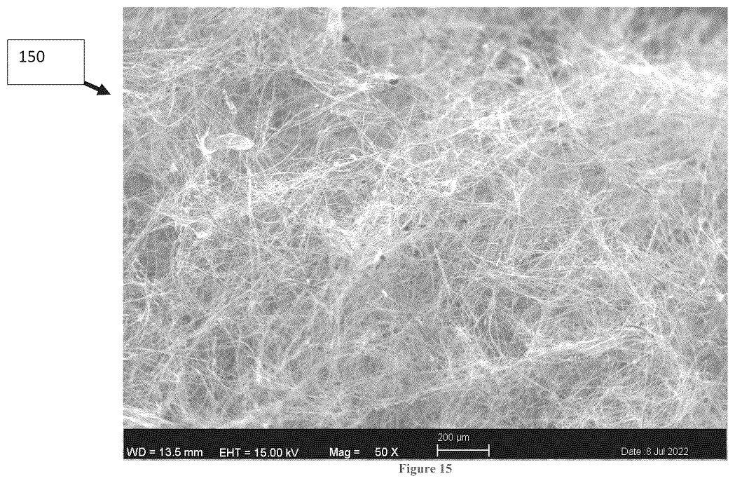

FIG. 4 is the general chemical formula for poly(lactic-co-glycolic acid) (PLGA) 400. The poly(lactic-co-glycolic acid) (PLGA) polymer 40 is a biodegradable material that will ablate, wear away, and/or break down over time.

FIG. 5 is the general chemical formula for polyglycidyl methacrylate (PGMA). The polyglycidyl methacrylate (PGMA) polymer 50 is a biodegradable material that will ablate, wear away, and/or break down over time.

FIG. 6 is a chart showing the MERV levels for air filters as prescribed by ASHRAE. A MERV level of 13 or higher has been prescribed by the CDC for air filtration in office buildings, schools, residences and other occupied interior spaces.

Another pathogen inactivating material is hypochlorous acid (HOCl). It has virucidal efficacy against viruses such as SARS-CoV-2. HOCl exists naturally in the human body. It is created by white blood cells as a defense system against infection, bacteria, fungi, and viruses. HOCl attacks invading pathogens by breaking down cell walls. HOCl as an antimicrobial acid is lethally effective as the body's natural response to bacteria. Thus, HOCl may be utilized as an effective virucidal and biocidal agent in an air filter device.

Another pathogen inactivating material is didecyldimethylammonium chloride (DDMAC). It is a broad spectrum bactericide, pathogen inactivating material, and fungicide and can be used as disinfectant cleaner for linen, recommended for use in hospitals, hotels and industries.

Yet another pathogen inactivating material is chlorhexidine. It is a broad spectrum disinfectant and antiseptic utilized in surgical procedures.

Other pathogen inactivating materials may also be utilized. These include chlorinated material, quaternary ammonium salts, peroxides, acids, bases, and others.

The inventors appreciate and recognize that, at a molecular level, almost all materials are constantly in a state of change and, in its most extreme construction, one could take the position, at the molecular level, that most materials and objects are wearing away at all times. However, in this application, Applicant is acting as its own lexicographer and uses “wear away” having a very particular meaning as described in the following disclosure.

The change that occurs polymers over time takes place in various forms. Two major changes typically observed are surface changes and bulk changes of the polymer matrix. One measurement for the active transport process in polymers is the second Damköhler number. The Damköhler number was defined by German chemist Gerhard Damköhler in 1936 and is commonly used to characterize the relative magnitude of convection time scale and chemical reaction time scale. In its most commonly used form, the first Damköhler number relates the reaction timescale to the convection time scale, volumetric flow rate, through the reactor for continuous (plug flow or stirred tank) or semi-batch chemical processes or general chemical reaction processes. The second Damköhler number relates to diffusion-controlled chemical reaction processes. Thus, the second Damköhler number tends to be an indicator of either surface or bulk degradation of a polymer.

In reacting systems that include interphase mass transport, the second Damköhler number (Dₐ_{_{II}}) is defined as the ratio of the chemical reaction rate to the mass transfer rate. It is also defined as the ratio of the characteristic fluidic and chemical time scales.

The second Damköhler number may be utilized to describe surface versus bulk degradation based on the mass transfer of materials at the polymer/environmental interface.

$${D}_{{a}_{II}} = {k}_{eff} / \frac{{D}_{{H}_{2} O}}{{L}^{2}}$$

Where k_{eff}=reaction rate constant with units of time of 1/seconds, D_{H}_{₂}_{O}=diffusivity (of water here) within the polymer and has units of meters²/seconds, and L²=shortest distance from the surface of the polymer to the core of the polymer and would be in meters. The diffusivity coefficient, D, may also be other gases or liquids that would diffuse into the polymer including oxygen.

Bulk degradation is the breaking of any polymer bond breaking at any time. An example of this is hydrolytic degradation where water diffuses freely through out the polymer structure. As a result of the bulk degradation, the volume remains constant but the chemical bonds decrease in number.

Surface degradation, on the other hand, is where only the polymer bonds on the surface are degraded and the core of the polymer remains intact. As a result of the constant surface degradation, the volume will decrease with time but within the remailing solid, the bonds are constant.

Thus, very high k_{eff} and a low D_{H}_{₂}_{O} would be associated with surface degradation and a low k_{eff} and high D_{H}_{₂}_{O} would be associated with bulk degradation.

Ablative polymers will be associated with a very high k_{eff} and a low D_{H}_{₂}_{O} while sacrificial polymers will be associated with a low k_{eff} and high D_{H}_{₂}_{O}.

Polymers with surface degradation will have a high second Damköhler number while polymers with bulk degradation will have a low second Damköhler number. In some embodiments, polymers exhibiting surface degradation will have a second Damköhler number greater than 1 (e.g., in a range from 1-2, 1-3, 1-5, or 1-10). In some embodiments, polymers exhibiting bulk degradation will have a second Damköhler number less than 1 (e.g., in a range from 0-1, 0-0.5, or 0.5-1).

The second Damköhler number (Dₐ_{_{II}}) is, as discussed, a methodology for describing the surface or bulk degradation of the material. The Dₐ_{_{II}} incorporates both a rate constant, k effective (k_{eff}), and a diffusion mass transfer rate (D_{H2O}) with the diffusing material, in this case, being water. The length term, L², as an important influence on the surface or bulk degradation as it signifies the distance from the surface to the core of the degrading material. So, a high k_{eff} will allow for degradation at the surface of a polymer as a reaction rate is high. Thus, ablation. Similarly, a low diffusivity of water, D_{H2O}, will also allow for surface degradation of the polymer as water is not diffusing into the polymer matrix. Thus, here again, ablation. So, if the second Damköhler number is greater than one, typically it is surface degradation while if the second Damköhler number is less than one, it is typically bulk degradation. Thus, a Dₐ_{_{II}} greater than one for ablation and less than one for bulk degradation.

This process is also seen in degradable sutures. Typically, the absorbable stitches or degradable sutures are copolymers of poly glycolic acid, PGA, and poly lactic acid, PLA. Starting with a homopolymer of PGA, there is lower diffusivity of water and thus a longer time to degrade. As more PLA is copolymerized with PGA, the diffusivity of water increases and the degradation increases as well. However, what may be somewhat counterintuitive, a homopolymer of PLA has a similar or slightly longer time of degradation as does a homopolymer of PGA due to the low diffusivity of water for the homopolymer of PLA. The low diffusivity of water is due to the ordered polymer chains for the homopolymer of PGA in the homopolymer of PLA. When a copolymer is produced, the polymer becomes more amorphous and allows for a higher diffusivity of water and thus a faster degradation. So, dissolvable sutures may be throttled as to their dissolution rate depending upon the ratio of the PGA to PLA in the copolymer making up the sutures. They may also be throttled as to their dissolution rate based on the tacticity, in and out of plane bending, of the polymer constituents (PLA has an extra methyl group versus PGA and thus a different tacticity).

A degradation labile molecule may be built into the backbone of the polymer so as to increase the ablation or sacrifice of the polymer over time. This degradation labile molecule may include a starch molecule or a cellulose molecule.

The degradation labile molecule may also be subject to enzymatic degradation through the use of a specific enzyme that is incorporated into the polymer matrix.

The enzyme in the polymer matrix may be encapsulated so as to be released over time. The encapsulation of the enzyme may be such that the encapsulation will degrade and release the enzyme at different time intervals. This may be accomplished through the use of the material such as polyvinyl alcohol where the molecular weight of the polyvinyl alcohol is modified to increase or decrease the degradation of the encapsulation portion of the encapsulated enzyme.

The activation of the enzymatic process may also be triggered by an external event such as a change in pH or a change in the humidity of the air flowing through the air filter.

The tacticity of the polymer will also have an effect on the degradation of the polymer matrix. The tacticity of a polymer is the relative stereochemistry of adjacent chiral centers within a macromolecule such as a polymer. The changes in the stereochemistry will allow for more or less diffusivity into the polymer matrix of materials that will cause degradation of the polymer matrix, such as water.

The release of the pathogen inactivating material or biocide from the ablative or sacrificial polymer may also be modulated through the use of oil absorbent materials such as silicas, talcs, clays, molecular sieves, materials with a high degree of porosity such as diatomaceous earth, Zeolites, silica gel and other absorptive materials that may be incorporated into the polymer matrix. The oil absorption indicates how much resin or polymer the mineral absorbs, also known as the resin demand.

The absorptive materials may be microporous, mesoporous, or macroporous. Microporous materials will have pores that are less than 2 nm. Mesoporous materials will have pores from 2 nm to 50 nm. Macroporous materials will have poor openings from 20 to 100 nm.

Release of a pathogen inactivating material or biocide from the oil absorptive materials will depend upon the environmental conditions once they are exposed to the environment after the sloughing off of the ablative polymer or the breakdown of the sacrificial polymer. Temperature, atmospheric pressure, and humidity will play a role in the release of the pathogen inactivating material or biocide from the absorptive materials once exposed to the environment.

The ablation or sacrifice of the polymer matrix may be modulated through the modification of the polymer matrix by the incorporation of materials such as cellulosic materials and starch materials. The process of ablation or sacrifice of the polymer matrix may be increased through the use of hydrophilic moieties and enzymatic materials which will help to increase the speed of degradation, either through ablation or sacrificial processes, of the polymer matrix.

The ablation or sacrifice of the polymer matrix may also be modulated through the modification of the polymeric bonds so as to increase or decrease the ablation or sacrifice of the polymeric matrix. For instance, ester bonds may be grafted into the backbone of the polymer matrix to allow for an area of chain scission via hydrolysis from interaction with water molecules.

Another molecule that may be grafted into the backbone of the polymeric matrix are starch molecules. For instance, a polyvinyl acetate-starch copolymer may be produced.

A polyvinyl acetate butyl acrylate copolymer may also be copolymerized with the starch molecule such that a starch molecule is built into the backbone of the vinyl acetate butyl acrylate copolymer.

The use of a starch enzyme may allow for cleavage of the polymer backbone of the vinyl acetate butyl acrylate copolymer starch complex. One such enzyme is amylase. The enzymatic action of the amylase enzyme will allow for the breakdown of the polymeric matrix over time.

Another molecule may be grafted into the backbone of the polymer matrix is cellulose. A cellulose type molecule grafted into the backbone of a vinyl acetate acrylic acid copolymer, such as a vinyl acetate butyl acrylate copolymer or a vinyl acetate 2-ethyl hexyl acrylate copolymer will allow the polymeric matrix to be susceptible to both surface breakdown, and thus a ablative polymer matrix, and bulk breakdown, and thus a sacrificial polymer matrix.

Enzymes that will act on the cellulosic portion of a vinyl acetate acrylic acid cellulose polymer matrix include cellulase, cellobiohydrolase, and beta-glucosidase.

The polymer matrix with molecules polymerized into the backbone, such as starch and cellulose, may be blended with appropriate enzymes such that the polymer matrix will break down over time. The enzymes may be blended into the polymer matrix in a large amount or a small amount, depending upon how fast the polymer matrix is intended to break down over time.

In another embodiment, the enzyme is encapsulated in a secondary polymer, such as polyvinyl alcohol. This encapsulated enzyme is then incorporated into the polymer matrix, such as a vinyl acetate butyl acrylate copolymer, a vinyl acetate 2-ethyl hexyl acrylate copolymer, or modified version of a polymeric matrix such as a starch or cellulose modified version of a polymeric matrix.

As the ablative or sacrificial polymer degrades, the encapsulated enzyme may be released so as to further degrade the polymeric matrix. The encapsulating polymer for the enzyme may be modified to degrade at different rates depending upon the intended degradation of the polymer matrix. Also, the amount of the encapsulated enzyme in the polymer matrix may be modified so as to modify the ablative or sacrificial nature of the polymer matrix.

The enzymatic material may also be adsorbed onto adsorptive substrate such as silica gel, molecular sieves, and zeolites. This will allow the enzymatic material to be released over time as it desorbs from the adsorptive substrate.

Natural polymers, such as a mixture of amylose and amylopectin, may also be utilized as a polymer matrix. Here, amylase may be utilized as an enzymatic degradation material to break down the amylose and amylopectin.

Enzymes may also be utilized to scission the backbone of the polymer forming the polymer matrix. These include both lipases and esterases. Enzymes act in a “lock” and “key” methodology where the enzyme will catalyze a chemical process at a high rate of reaction by temporarily bonding to a molecule (the “key”) to turn on a chemical reaction (the “lock”) and produce a new reaction product. This enzymatic interaction typically lowers the activation energy of the reaction process.

The enzymatic process may be throttled through several means including changes in pH, the elimination or addition of enzymatic cofactors, the addition of inhibitors that will bind to enzymatic sites, and changes in temperature. This enzymatic throttling process may be used to increase or decrease the ablative or sacrificial nature of the polymeric material.

Thus, several types of polymer matrix are described wherein a chemical moiety, such as a starch or cellulose, may be polymerized into the backbone of the polymer matrix so as to facilitate the ablative or sacrificial nature of the polymer matrix. This process may also be modified through the use of enzymatic materials where the enzymatic materials themselves may be modified to be more or less active through both encapsulation and enzymatic inhibition.

The coating of a substrate with the polymer matrix may be seen, in one aspect, by various magnifications of a scanning electron microscope (SEM). The polymer matrix is an ablative or sacrificial polymer infused with a pathogen inactivating material.

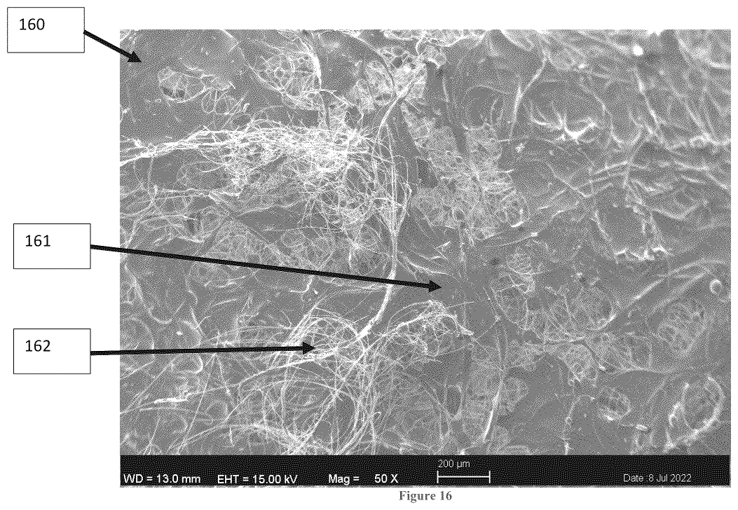

A micrograph of uncoated fiberglass fibers in a nonwoven configuration 150 is shown at 50 times magnification in FIG. 15.

In FIG. 16, a micrograph 160 of a coated substrate is comprised of a polymer matrix coating infused with a pathogen inactivating material where the polymer matrix forms both areas of coating 161 and individual coating of fiberglass fibers 162 shown at a magnification of 50 times.

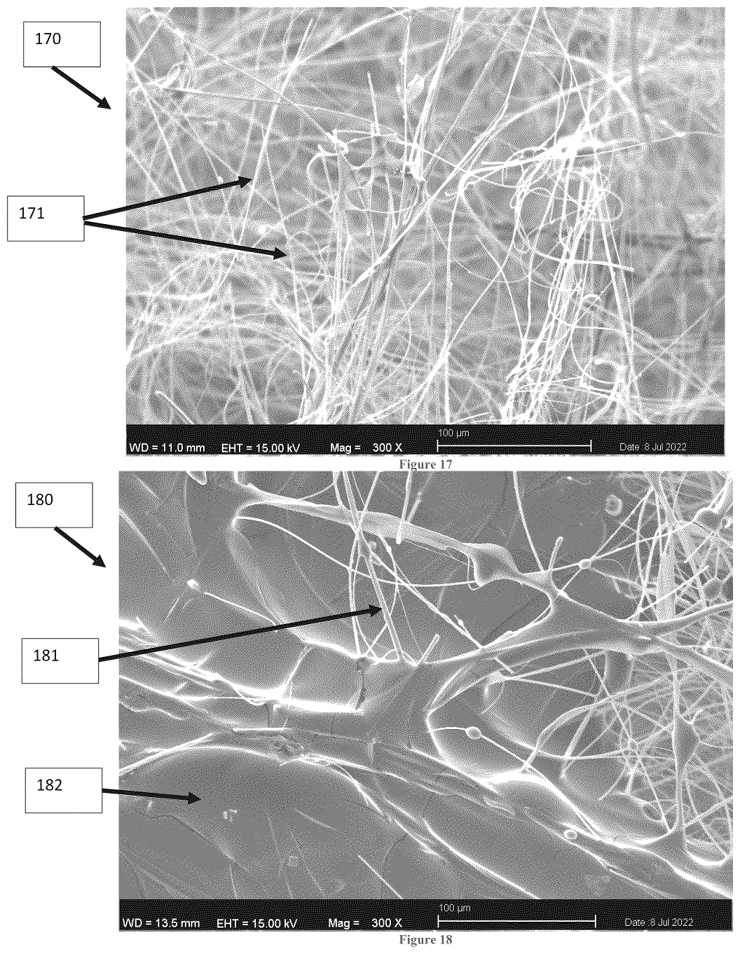

In FIG. 17, a micrograph 170 shows an unwoven fiberglass substrate at a magnification of 300 times where the fiberglass substrate 171 is uncoated.

In FIG. 18, a micrograph 180 shows both areas of the pathogen inactivating material infused polymer matrix coating 182 and individual fibers 181 with the pathogen inactivating material infused polymer matrix coating.

Air flow tests for a nonwoven fiberglass MERV-14 substrate were conducted utilizing two test criteria. The first test criteria was the airflow through an uncoated nonwoven fiberglass substrate and a nonwoven fiberglass MERV-14 substrate that was spray coated with an emulsion polymer matrix containing a polyvinyl acetate 2-ethylhexyl acrylate polymer infused with a Stepan BTC-885 pathogen inactivating material. The test performed was ASTM D-737 Air Permeability Test utilizing an SDL Atlas MO21A air permeability tester.

TABLE 6

| | |
|---|---|
| Sample 001 | Sample 002 |

| | | | |
|---|---|---|---|
| 58.4 | 61.1 | 61.3 | 55.7 |
| 60.7 | 63.1 | 69.2 | 57.4 |
| 58.2 | 62.9 | 56.5 | 55.2 |
| 56.7 | 58.8 | 59.2 | 71.3 |

| | |
|---|---|
| 59.9875 | 60.725 |

The results of the airflow testing of the nonwoven fiberglass materials may be seen in Table 6. The units of measure are ft³/minute/ft². Sample 001 is an uncoated nonwoven fiberglass substrate and Sample 002 is a coated fiberglass substrate. It may seen that the air flow is similar for the both the uncoated substrate and the coated substrate.

Thus, the spray coating of the pathogen inactivating material infused polymer matrix applied to the nonwoven substrate did not interfere with the airflow through the MERV-14 nonwoven fiberglass substrate.

The flow of particles through both an uncoated and a coated substrate was tested utilizing NIOSH procedure TEB-APR-STP-0059 on a Automatic TSI 8130 filter tester.

Table 7 shows the results of the particle air flow test utilizing the Automatic TSI 8130 filter tester.

TABLE 7
FILTRATION EFFICIENCY RESULTS TABLE

| | Manufacturer/ | | | Test | Flow Rate | Pressure | Penetration | Filtration |
|---|---|---|---|---|---|---|---|---|
| Sample ID | Model | Description | Standards | No. | ( [symbol] pm) | (mmH20) | (%) | (%) |
| IPAC-001-14-DEC-21 | | Yellow fiberglass nonwoven, | | 1 | 85.26 | 6.61 | 43.83 | 5 [symbol] .17 |
| | | 102 [symbol] 1442 3 AFS | | | | | | |
| IPAC-001-14-DEC-21 | | Yellow fiberglass nonwoven, | | 2 | 85.21 | 7.12 | 40.12 | [symbol] . [symbol] 8 |
| | | 102 [symbol] 1442 3 AFS | | | | | | |
| IPAC-001-34-DEC-21 | | Yellow fiberglass nonwoven, | | 3 | 85.25 | 6.83 | 42.09 | 57.91 |
| | | 102 [symbol] 1442 3 AFS | | | | | | |
| IPAC-001-14-DEC-21 | | Yellow fiberglass nonwoven, | | 4 | 85.09 | 7.60 | 37.2 [symbol] | [symbol] 2.72 |
| | | 102 [symbol] 1442 3 AFS | | | | | | |
| IPAC-002-14-DEC-21 | | Yellow fiberglass nonwoven, | | 1 | 85.13 | 6.73 | 47.91 | 52.0 [symbol] |
| | | 102 [symbol] 1441 3 AFS | | | | | | |
| IPAC-002-14-DEC-21 | | Yellow fiberglass nonwoven, | | 2 | 85.27 | 7.57 | 41.67 | 58.33 |
| | | 102 [symbol] 1441 3 AFS | | | | | | |
| IPAC-002-14-DEC-21 | | Yellow fiberglass nonwowen, | | 3 | 85.19 | 6.82 | 45.50 | 54.50 |
| | | 102 [symbol] 1441 3 AFS | | | | | | |
| IPAC-002-14-DEC-21 | | Yellow fiberglass nonwoven, | | 4 | 85.23 | 6.75 | 45.96 | 54.04 |
| | | 102 [symbol] 1441 3 AFS | | | | | | |

NOTES: [symbol]
A bank cell indicates that no data was available. [symbol]
indicates data missing or illegible when filed

The IPAC-001-14-DEC-21 sample is the control with no polymer matrix coated on the fiberglass substrate and the IPAC-002-14-DEC-21 sample is spray coated with the pathogen inactivating material infused polymer matrix. The fiberglass substrate is a nonwoven MERV-14 filter material.

The test material and preconditioning of the samples for the particle transmission in accordance with NIOSH procedure TEB-APR-STP-0059 are shown in table 8.

TABLE 8

| | |
|---|---|
| Sample preconditioning details: | 38 deg C., 85% RH for 25 +/− 1 hour |
| Aerosol: | 2% NaCL + Water |

The test results in table 7 show that there is no difference in the particle flow between the uncoated sample and the coated sample.

In the case of a spray process, the particles in the spray stream may be modified so as to penetrate into the woven or nonwoven substrate that is being utilized as the base material for the air filter. This may be done through regular atomization of the polymer matrix and pathogen inactivating material mixture. The atomization of the spray of the polymer matrix and pathogen inactivating material matrix solution may also be enhanced through various methods such as the use of a high velocity low pressure (HVLP) spray nozzle. A piezoelectric spray nozzle may also be utilized to improve the atomization of the polymer matrix and pathogen inactivating material solution.

In one aspect of the polymer matrix with the pathogen inactivating material, an indicator dye or colorants may be utilized so as to indicate the coverage of the sprayed material onto a substrate. An indicator dye or colorants may be utilized also to indicate the lifespan of the filter system and when a replacement is necessary. For instance, a blue dyed may be added to the polymer matrix and pathogen inactivating solution such that, after the solution is sprayed and dried onto a substrate, the die will fade over time, such as 30 days, the indicate the need for the replacement of the air filter.

The air filter may also have a means for detecting viral material that is impinged upon the filter. One such means for detecting the viral material is the utilization of single-stranded DNA couple to a microchip. When a material binds to the single-strand DNA, such as a single-strand RNA that is characteristic of the SARS-CoV-2, a difference in electrical charge may be determined by the microchip attached to the single-strand DNA. This electrical difference in the microchip will allow for the determination of the attachment of a specific RNA strand to a detector. As more and more RNA strands attached to the single-strand DNA, more of an indication may be seen from the microchip attached to the DNA single-strand material. This will generate a signal that will show the amount of single-stranded RNA attached to the single-strand DNA and thus identify both the viral load and the variant of the virus that is being detected. For instance, a single-stranded DNA with the sequence that matches the single stranded RNA of the Delta variant of the SARS-CoV-2 virus will bind with the viral RNA and cause a change in the electrical characteristics of the biosensor chip. This will show not only that the Delta variant is present but also the amount of Delta variant that is present.

The single-stranded DNA (ssDNA) detector may also be utilized to check the efficacy of the pathogen inactivating material filter. An ssDNA detector may be mounted downstream of a pathogen inactivating material infused filter such that the air passing through the pathogen inactivating material infused filter will subsequently come in contact with the ssDNA detector. The ssDNA detector will then detect any viral load that is coming through the pathogen inactivating material infused filter, indicating that the efficacy of the pathogen inactivating material infused filter has been lessened and report this lower pathogen inactivating material all activity through an electronic communication means.

The ssDNA detector may also be utilized as part of a system to indicate viral loads in a building or structure. The detectors may be placed in various areas of the building or structure and connected into a communications system, similar to a fire reporting communications system, such that viral infections in a building or structure, such as a hospital, may be registered and recorded and dealt with appropriately.

Another aspect of this embodiment is the use of a specialized pathogen inactivating material, such as an RNA nuclease, to inactivate viral pathogens. The use of a Clustered Regularly Interspaced Short Palindromic Repeats (CRISPR)/CRISPR associated protein 13 (Cas13) may be utilized to cleave RNA nucleic acid sequences. In one manner, RNA nucleases cleave the phosphodiester bonds of nucleic acids in the RNA, inactivating a single stranded RNA virus (ssRNA) such as SARS-CoV-2. A phosphodiester bond is shown in FIG. 7. Cas13 targets RNA, not DNA. When it is activated by a ssRNA sequence that is complementary to its CRISPR-RNA (crRNA) spacer, the Cas13 releases nonspecific RNase activity and inactivates RNA in the Cas13 vicinity without regards to the RNA sequence. Thus, Cas13 coupled with crRNA forms a complex that may effectively inactivate ssRNA viruses such as SARS-CoV-2.

The CRISPR type of viral inactivation allows for rapid response to variance of a microorganism, e.g., a pathogen such as the SARS-CoV-2 virus. Thus, new versions of the SARS-CoV-2 virus, such as the delta variant or the omicron variant, may be quickly inactivated.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A polymer matrix comprising:
a polymer mixed with an antimicrobial agent, wherein the polymer is an ablative polymer or a sacrificial polymer that will degrade over time in either a surface or bulk degradation method.

2. The polymer matrix of claim 1, further comprising a degradation labile molecule built into a backbone of the polymer.

3. The polymer matrix of claim 2, wherein the degradation molecule is polymerized into the backbone of the polymer.

4. The polymer matrix of claim 2, wherein the degradation molecule is copolymerized into the backbone of the polymer.

5. The polymer matrix of claim 2, further comprising an enzyme adapted to increase the speed of the degradation of the polymer matrix either through an ablative process or a sacrificial process.

6. The polymer matrix of claim 1, wherein the polymer has a high second Damköhler number.

7. The polymer matrix of claim 6, wherein the second Damköhler number is greater than 1.

8. The polymer matrix of claim 1, where the polymer has a low second Damköhler number.

9. The polymer matrix of claim 8, wherein the second Damköhler number is less than 1.

10. The polymer matrix of claim 1, where the polymer matrix further comprises an absorptive material.

11. The polymer matrix of claim 10, wherein the absorptive material is selected from the group consisting of silica gel, molecular sieve, clay, or zeolite material.

12. The polymer matrix of claim 10, where the antimicrobial agent is absorbed onto the absorptive material.

13. The polymer matrix of claim 1, wherein the antimicrobial agent comprises a pathogen inactivating material.

14. An air filter comprising:
a substrate; and
the polymer matrix of claim 1.

15. A method of making a polymer matrix, the method comprising the steps of: mixing a polymer with an antimicrobial agent, wherein the polymer is an ablative polymer or a sacrificial polymer that will degrade over time in either a surface or bulk degradation method.

16. The method of claim 15, further comprising the step of building a degradation labile molecule into a backbone of the polymer.

17. The method of claim 16, further comprising adding an enzyme adapted to increase the speed of the degradation of the polymer matrix either through an ablative process or a sacrificial process.

18. The method of claim 15, wherein the polymer has a high second Damköhler number.

19. The method of claim 15, where the polymer has a low second Damköhler number.

20. The method of claim 15, further comprising adding an absorptive material.
